(19) United States
(12) Patent Application Publication
(10) Pub. No.: US 2024/0377651 A1
(43) Pub. Date: Nov. 14, 2024

(54) Camera With Sensor Shift Tilt Actuator Arrangement

(71) Applicant: Apple Inc., Cupertino, CA (US)

(72) Inventors: Zilun Gong, Danville, CA (US); Paulom Shah, San Jose, CA (US); Yu-Min Lee, Saratoga, CA (US)

(73) Assignee: Apple Inc., Cupertino, CA (US)

(21) Appl. No.: 18/434,673

(22) Filed: Feb. 6, 2024

Related U.S. Application Data
(60) Provisional application No. 63/502,015, filed on May 12, 2023.

(51) Int. Cl. G02B 27/64; G03B 3/12; G03B 5/06; G03B 5/08; H04N 23/54; H04N 23/55

(52) U.S. Cl. CPC G02B 27/646; G03B 3/12; G03B 5/06; G03B 5/08; H04N 23/54; H04N 23/55; G03B 2205/0069

(57) ABSTRACT

Various embodiments include a camera system having a tilt actuator arrangement for tilting an image sensor. For example, the tilt actuator may be used to tilt the image sensor, relative to a lens group of the camera system, to provide tilt compensation and/or optical image stabilization (OIS). The tilt actuator arrangement may include one or more voice coil motor (VCM) actuators. According to various embodiments, the VCM actuator(s) may include fixed drive magnets and movable drive coils. The drive magnets may be coupled with a housing of the camera system. The drive coils may be coupled with a substrate, and the substrate may also be coupled with the image sensor, such that the image sensor and the substrate move together.

### PRIORITY APPLICATION

This application claims benefit of priority to U.S. Provisional Application Ser. No. 63/502,015, entitled “Camera With Sensor Shift Tilt Actuator Arrangement,” filed May 12, 2023, and which is hereby incorporated herein by reference in its entirety.

### BACKGROUND

### Technical Field

This disclosure relates generally to a camera that includes a tilt actuator arrangement for tilting an image sensor, e.g., to provide tilt compensation and/or optical image stabilization (OIS).

### Description of the Related Art

The advent of small, mobile multipurpose devices such as smartphones and tablet or pad devices has resulted in a need for high-resolution, small form factor cameras for integration in the devices. Some small form factor cameras may incorporate optical image stabilization (OIS) mechanisms that may sense and react to external excitation/disturbance by adjusting location of the optical lens on the X and/or Y axis in an attempt to compensate for unwanted motion of the lens. Some small form factor cameras may incorporate an autofocus (AF) mechanism whereby the object focal distance can be adjusted to focus an object plane in front of the camera at an image plane to be captured by the image sensor. In some such autofocus mechanisms, the optical lens is moved as a single rigid body along the optical axis of the camera to refocus the camera.

### BRIEF DESCRIPTION OF THE DRAWINGS

FIGS. 1A-1B illustrate views of an example camera system that includes an actuator arrangement, in accordance with some embodiments. FIG. 1A shows a perspective view of the camera system. FIG. 1B shows a schematic side cross-sectional view of the camera system 100, taken at section line 1B-1B indicated in FIG. 1A.

FIG. 2 illustrates a schematic side cross-sectional view of an example camera system that includes a tilt actuator arrangement, in accordance with some embodiments.

FIG. 3 illustrates a schematic side cross-sectional view of an example camera system that includes an autofocus (AF) actuator arrangement, in accordance with some embodiments.

FIG. 4 illustrates a schematic side cross-sectional view of an example camera system that includes one or more motion damping arrangements, in accordance with some embodiments.

FIG. 5 illustrates a schematic view of an example fixed drive magnet arrangement relative to an underside of a housing (e.g., a shield can), in accordance with some embodiments.

FIG. 6 illustrates a schematic view of an example drive coil arrangement relative to upper surface of a substrate, in accordance with some embodiments.

FIGS. 7A-7B illustrate views of an example camera system having an interior portion that is completely encased, in accordance with some embodiments. FIG. 7A shows a schematic side cross-sectional view of the camera system. FIG. 7B shows a schematic top view of the camera system.

FIGS. 8A-8B illustrate views of an example sensor shift suspension arrangement (e.g., a flexure-based sensor shift suspension arrangement) of a camera system that may include a tilt actuator, an AF actuator, and/or one or more damping arrangements, in accordance with some embodiments. FIG. 8A shows a schematic side cross-sectional view of the sensor shift suspension arrangement including a flexure.

FIG. 8B shows a schematic top view of the flexure.

FIG. 9 is a flowchart that illustrates an example method of operating a camera system that is capable of implementing tilt actuation and/or autofocus (AF) actuation, in accordance with some embodiments.

FIG. 10 is a flowchart that illustrates an example process of assembling, at least in part, a camera system that is capable of implementing tilt actuation, autofocus (AF) actuation, and/or motion damping, in accordance with some embodiments.

FIG. 11 illustrates a schematic representation of an example environment comprising a device that may include a camera system with a tilt actuator, an AF actuator, and/or one or more damping arrangements, in accordance with some embodiments.

FIG. 12 illustrates a schematic block diagram of an example environment comprising a computer system that may include a camera system with a tilt actuator, an AF actuator, and/or one or more damping arrangements, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments include a camera system having a tilt actuator arrangement for tilting an image sensor, e.g., to provide tilt compensation/correction and/or optical image stabilization (OIS). In some embodiments, the camera system may include a lens group, an image sensor, the tilt actuator arrangement (e.g., comprising one or more voice coil motor (VCM) actuators), and a substrate. The tilt actuator arrangement may be used to tilt the image sensor, together with the substrate (which may be fixedly coupled with the image sensor), relative to the lens group.

The VCM actuator(s) may include fixed drive magnets that are fixedly coupled with a stationary component of the camera system. In some embodiments, the fixed drive magnets may be considered “corner” drive magnets, each of which may be positioned proximate a respective corner of the camera system. Furthermore, the VCM actuator(s) may include drive coils that are fixedly coupled with the substrate. In some embodiments, drive coils may be considered “corner” drive coils, each of which may be positioned proximate a respective corner of the camera system.

According to various embodiments, each respective drive coil may be positioned proximate a respective fixed drive magnet such that, when driven with electric current, one or more of the drive coils are capable of electromagnetically interacting with one or more of the fixed drive magnets to tilt the image sensor relative to the lens group. The VCM actuator(s) may be capable of tilting the image sensor about multiple axes orthogonal to an optical axis of the camera system, e.g., to compensate for “pitch” and “yaw” tilt/rotation (and/or to provide OIS) in various embodiments.

In various embodiments, the fixed drive magnets may have a respective polarity along a vertical direction parallel to the optical axis. For example, each of the fixed drive magnets may be oriented such that one pole (e.g., south magnetic pole S) is disposed above the other pole (e.g., north magnetic pole N) in the vertical direction.

Additionally, or alternatively, in various embodiments the camera system may include an autofocus (AF) actuator arrangement. The AF actuator arrangement (e.g., comprising one or more VCM actuators) may be used to move/shift the image sensor, together with the substrate (which may be fixedly coupled with the image sensor), relative to the lens group, e.g., to provide AF.

According to various embodiments, the VCM actuator(s) may include fixed drive magnets that are fixedly coupled with a stationary component of the camera system. In some embodiments, the fixed drive magnets may be considered “corner” drive magnets, each of which may be positioned proximate a respective corner of the camera system. Furthermore, the VCM actuator(s) may include drive coils that are fixedly coupled with the substrate. In some embodiments, drive coils may be considered “corner” drive coils, each of which may be positioned proximate a respective corner of the camera system.

According to various embodiments, each respective drive coil may be positioned proximate a respective fixed drive magnet such that, when driven with electric current, one or more of the drive coils are capable of electromagnetically interacting with one or more of the fixed drive magnets to move the image sensor in at least one direction parallel to the optical axis.

In various embodiments, the fixed drive magnets may have a respective polarity along a vertical direction parallel to the optical axis. For example, each of the fixed drive magnets may be oriented such that one pole (e.g., south magnetic pole S) is disposed above the other pole (e.g., north magnetic pole N) in the vertical direction.

Additionally, or alternatively, in various embodiments the camera system may include one or more motion damping arrangements. For example, the camera system may include an electromagnetic damping arrangement and/or an air damping arrangement.

In some embodiments, the electromagnetic damping arrangement may include one or more damping coils (e.g., closed loop passive coil(s)). The damping coil(s) may be fixedly coupled with the substrate. In various embodiments, each damping coil may be positioned relative to a fixed drive magnet such that, when there is relative motion between the fixed drive magnet caused by motion of the substrate, the fixed drive magnet induces a current in the damping coil. The induced current may produce a magnetic field that opposes the motion of the substrate due to Lenz's law, thereby providing electromagnetic damping. The magnitude of the electromagnetic damping may be proportional to the speed of the motion. As the electromagnetic damping is completely passive, no drive current needs to be routed to or provided to the damping coil(s).

In some embodiments, each respective damping coil may be vertically aligned with a respective fixed drive magnet. Additionally, or alternatively, the damping coil(s) and the drive coils may be on opposite sides of the substrate. According to various embodiments, the camera system may include multiple corner damping coils. Each respective corner damping coil may be positioned proximate a respective corner of the camera system.

In some embodiments, the air damping arrangement may include the camera system being sealed and further designed so that one or more movable components push air within the camera system when in motion, causing air resistance. For example, the camera system may include a sealed environment, a portion of which may include a sealed interface between the lens group and a housing. In various embodiments, a desired amount of air damping may be achieved based at least in part on a size of the substrate, a size of the housing, and/or a size of a gap between the substrate and the housing.

In some other camera systems with sensor shift OIS, a flexure may hold the substrate and image sensor, while OIS coils on the substrate drive the image sensor in-plane to compensate for hand movement on pitch and yaw axes. Therefore, there is a trade-off between the module footprint and compensation angle in such systems. A larger image sensor may require proportionally more stroke to compensate for the same angle, which limits the ability to increase the size of the image sensor as well as the ability to improve OIS capability.

In those camera systems using in-plane translation to compensate pitch and yaw rotation, there is a native optical distortion post compensation. Furthermore, the residual tilt between the lens and the image sensor may be fixed after assembly, and there may be additional image sensor sag at different postures. This tilt cannot be corrected and can cause image quality degradation, especially for large image sensors. Moreover, those camera systems may have drive magnets whose polarities are in-plane. For example, a drive magnet's polarity may be perpendicular to the polarities of neighboring drive magnets. This structure can cause magnet shock to position sensors that may result in calibration drift.

With the camera systems disclosed herein, the drive magnet polarity may be along the vertical direction. For example, a camera system may include four drive coils on four corners of the substrate. In some non-limiting embodiments, the drive coils can be used to tilt the substrate about pitch and yaw axes, e.g., up to 3 degrees respectively. Four position sensors (e.g., each encircled by a respective drive coil) can track the substrate tilt in real-time, and a controller can be used to drive the drive coils so that the image sensor placed at target tilt position.

As compared to some of the other camera systems previously mentioned, the tilt actuator of the camera systems disclosed herein may allow for enhancing OIS performance with a larger image sensor without the penalty of significantly increasing the module footprint. In addition, the tilt actuator of the camera systems disclosed herein may be capable of correcting, on-the-fly, residual image sensor tilt from manufacture and additional image sensor sag at different postures. As the residual image sensor tilt from manufacture may be corrected on-the-fly, the camera systems disclosed herein may allow for eliminating an active alignment station from the manufacturing process (which other camera systems may require to correct for residual image sensor tilt), thereby providing a cost saving opportunity. Moreover, in the tilt actuator of the camera systems disclosed herein, the drive magnets may have the same polarity direction, which de-risks magnet shock to position sensors.

In some of the other camera systems with sensor shift OIS, the autofocus (AF) may rely on driving the lens to the focus portion, while the image sensor is stationary vertically. This may put a physical limit on the moving mass, and may prevent adding more optically advanced technologies on the lens, e.g., a glass lens, variable apertures, zoom-lens, etc.

To move heavy lenses, some other camera system architectures have a relatively complex arrangement of drive coils, position sensor board, and drivers. To track lens movement and tilt in real-time, one or two AF position sensors and a thermistor may be built-in, which may require calibration at a station during the manufacturing process. From a process perspective, the AF drive current and position sensor signals may be routed through jet-soldering between the position sensor board and a flexure. This kind of architecture may add mechanical complexity, process challenges, and reliability risk. For example, there failures may occur on jet solder interfaces, which may result in the lens not being able to focus.

Furthermore, such other camera systems may be limited by plastic lens elements, as the lens focal length may change significantly with temperature. This effect becomes even more significant as lens size grows. Addressing this issue may require a longer AF stroke, module height growth, and regression on minimum focus distance (macro distance). The plastic lens elements may be contained within a lens barrel, and some open space around the lens barrel may be required to allow for lens movement. The open space around the lens barrel may be a pathway for particle ingression, which may cause yield loss and field risk.

As compared to some of the other camera systems previously mentioned, the AF actuator of the camera systems disclosed herein may include drive magnets whose polarities are in the vertical direction. For example, a camera system may include four drive coils on four corners of the substrate. In some non-limiting embodiments, the drive coils can be used to move the image sensor plane to a target AF position. Four position sensors (e.g., each encircled by a respective drive coil) can track the substrate position in real-time with tilt information. The drive magnets and the lens group may be fixedly coupled with the same housing in some embodiments, which may free the lens group from mass constraints and improve module integrity.

The AF actuator of the camera systems disclosed herein may enable the use of a glass lens, which can reduce optical aberrations and reduce the lens temperature coefficient. Module height and minimum focus distance may also be reduced. Moreover, system complexity may be reduced while improving reliability, by reducing certain previously required processes and/or components, such as one or more drive coils, one or more position sensor boards, jet soldering, etc., which may also provide cost saving opportunities. As previously mentioned, in various embodiments the camera systems disclosed herein may be completely sealed, thereby mitigating particle ingression and making the module more robust in storage.

In some of the other camera systems with sensor shift OIS, a damping mechanism may be utilized to avoid oscillation or overshoot, as the image sensor moves with the substrate in-plane (e.g., to compensate for hand shake). Similarly, a damping mechanism may be utilized for AF, to prevent lens overshoot. For example, those camera systems may use damping pins inside of damping gel to form a “brake” for the OIS and/or AF actuator(s).

However, the use of damping pins inside of damping gel may present issues such as process challenges to reliability concerns. For example, damping gel may migrate in some cases, which can lead to premature controller failure after random vibration. A user may experience unstable OIS after normal usage if the damping gel cannot provide sufficient damping.

As compared to those other camera systems, the architecture of the camera systems disclosed herein may enable the utilization of electromagnetic damping and/or air damping. Regarding electromagnetic damping, in various embodiments the drive magnet polarity is along the vertical direction, so there is a magnetic flux gradient along the vertical direction. By including a closed loop passive coil on the substrate, aligning with the drive magnet, the closed loop passive coil will provide resistive force due to Lenz's law. This electromagnetic damping may be completely passive and proportional to speed of the moving mass. Regarding air damping, the camera module may be completely sealed and, during motion of the moving mass (e.g., including the substrate), the substrate pushes air which causes resistance.

These damping mechanisms may be used in the camera systems disclosed herein for motion damping during tilt correction, OIS, and/or AF motion, and may be more robust and enable improved reliability relative to the damping pin and damping gel mechanism previously discussed. Additionally, by removing certain components such as AF damping pins, AF damping gel, OIS damping pins, and OIS damping gel, the damping mechanisms of the camera systems disclosed herein may provide a cost saving opportunity.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

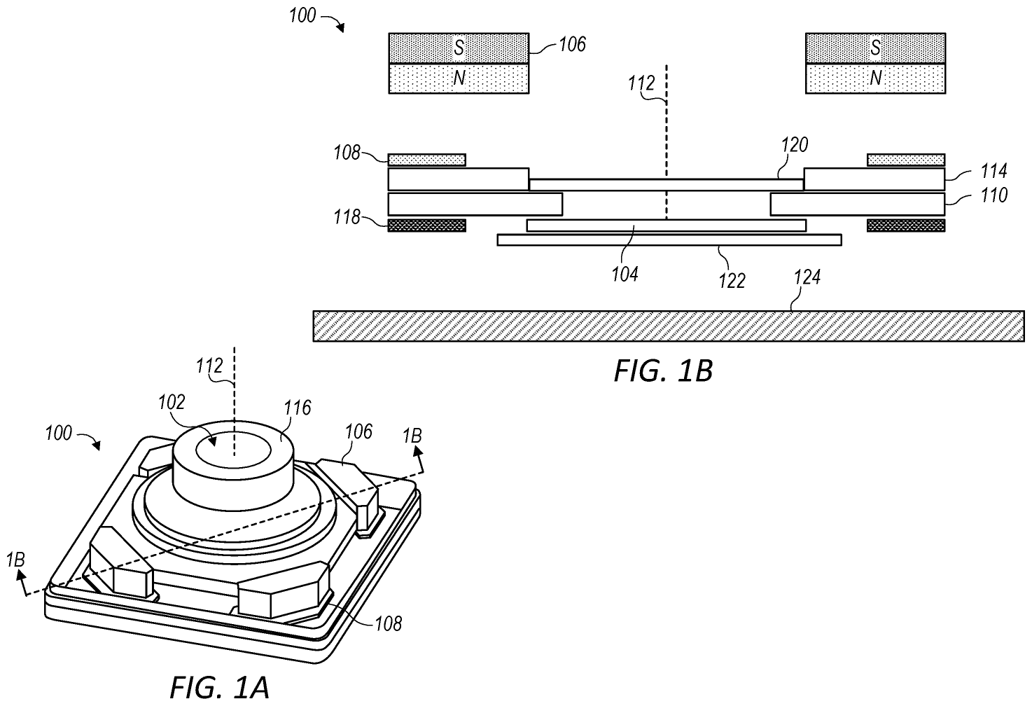

FIGS. 1A-1B illustrate views of an example camera system 100 that includes an actuator arrangement, in accordance with some embodiments. FIG. 1A shows a perspective view of the camera system 100. FIG. 1B shows a schematic side cross-sectional view of the camera system 100, taken at section line 1B-1B indicated in FIG. 1A.

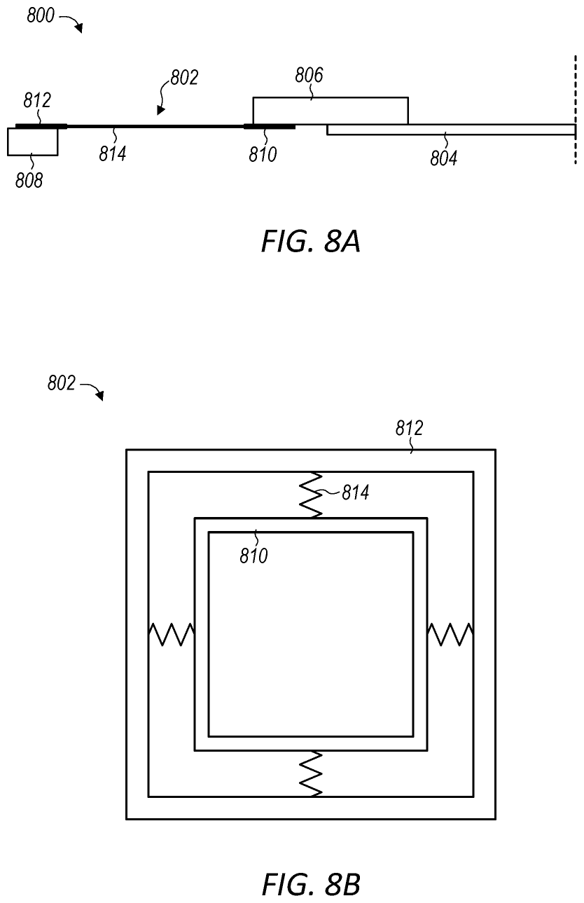

According to various embodiments, the camera system 100 may include a lens group 102, an image sensor 104, one or more voice coil motor (VCM) actuators (e.g., comprising fixed/stationary drive magnets 106 and drive coils 108), and/or a substrate 110 (also referred to herein as a “moveable carrier”). Furthermore, the camera system 100 may include a sensor shift suspension arrangement (not shown), which may include the substrate 110 in various embodiments. The sensor shift suspension arrangement may be used to suspend the substrate 110 (e.g., above a base structure of the camera system 100) while allowing motion of the substrate 110 enabled by the VCM actuator(s). A non-limiting example of a flexure-based sensor shift suspension arrangement is described herein with reference to FIGS. 8A-8B.

The lens group 102 may include one or more lens elements that define an optical axis 112 of the camera system 100. Additionally, or alternatively, the image sensor 104 may define an optical axis of the camera system 100. For example, the optical axis may be an axis that is orthogonal to a light-receiving surface of the image sensor 104.

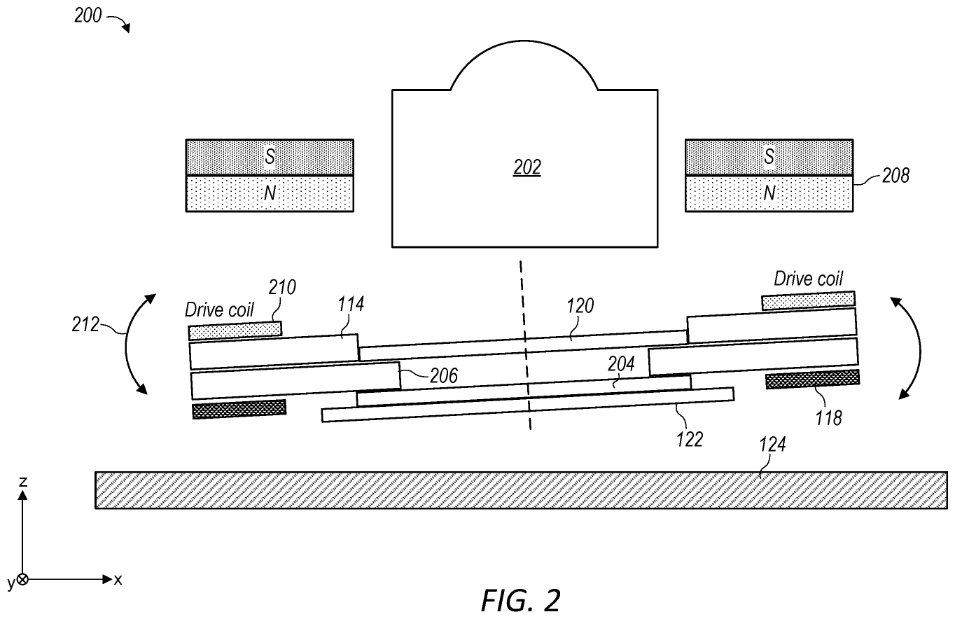

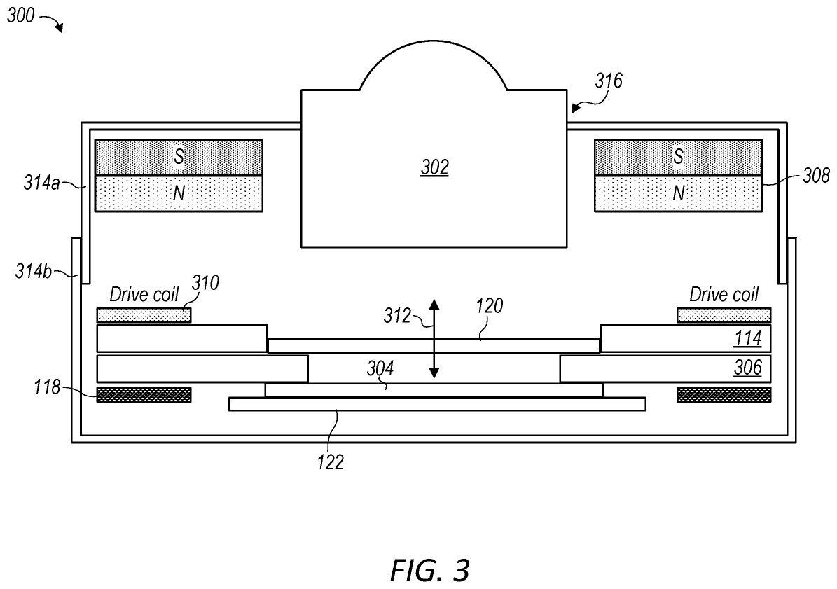

In various embodiments, the VCM actuator(s) may include fixed drive magnets 106 and drive coils 108. As used herein, a “fixed drive magnet” refers to a magnet having a position that is fixed relative to component(s) of the camera system 100 that are selectively movable via actuation. As will be discussed in further detail herein (e.g., with reference to FIG. 2), the VCM actuator(s) may be configured to tilt the image sensor 104 relative to the lens group 102, e.g., to provide tilt compensation and/or optical image stabilization (OIS). Additionally, or alternatively, as will be discussed in further detail herein (e.g., with reference to FIG. 3), the VCM actuator(s) may be configured to move the image sensor 104, relative to the lens group 102, in at least one direction parallel to the optical axis 112, e.g., to provide autofocus (AF).

In some embodiments, one or more of the fixed drive magnets 106 may have a respective polarity along a vertical direction parallel to the optical axis 112. For example, as indicated in FIG. 1B, each of the fixed drive magnets 106 may be oriented such that one pole (e.g., south magnetic pole S) is disposed above the other pole (e.g., north magnetic pole N) in the vertical direction.

According to various embodiments, the fixed drive magnets 106 may be fixedly coupled with a stationary component of the camera system 100. For example, the camera system 100 may be encase in a housing (e.g., comprising a shield can, such as shield can 314 in FIG. 3), and the fixed drive magnets 106 may be fixedly coupled with the housing. In some embodiments, the fixed drive magnets 106 may be considered “corner” drive magnets, each of which may be positioned proximate a respective corner of the camera system 100. For example, the housing may have side walls with surfaces extending along planes that are parallel to the optical axis 112. Pairs of the side walls that meet may form the corners at or near which the fixed drive magnets 106 may be located. According to some embodiments, the substrate 110 may have a surface, orthogonal to the optical axis 112, that is quadrilateral in shape. Each of the fixed drive magnets 106 may be positioned proximate a respective corner of the quadrilateral in some embodiments.

In various embodiments, the drive coils 108 may be fixedly coupled with the substrate 110. In some embodiments, the drive coils 108 may be considered “corner” drive coils, each of which may be positioned proximate a respective corner of the camera system 100. For example, the drive coils 108 may be positioned proximate a respective corner formed by the housing and/or formed by the substrate 110, e.g., similar to the corner positions previously mentioned regarding corner drive magnets. Each respective drive coil 108 may be positioned, in a respective axis parallel to the optical axis 112, between a respective fixed drive magnet 106 and the substrate 110 in some embodiments.

In some embodiments, the camera system 100 may further include a flexible printed circuit (FPC) 114 on which the 108 may be disposed. As indicated in FIG. 1B, the FPC 114 may be coupled with the substrate 110. For example, the FPC 114 may be on an upper surface of the substrate 110 in some embodiments.

As previously mentioned, the lens group 102 may include one or more lens elements. In some embodiments, the lens group 102 may include one or more glass lens elements. Additionally, or alternatively, the lens group 102 may be a fixed lens group. For example, the lens group 102 may be fixedly attached to a stationary component (e.g., a shield can) of the camera system 100. In some embodiments, the lens group 102 may be held within a lens barrel (e.g., lens barrel 116 in FIG. 1A).

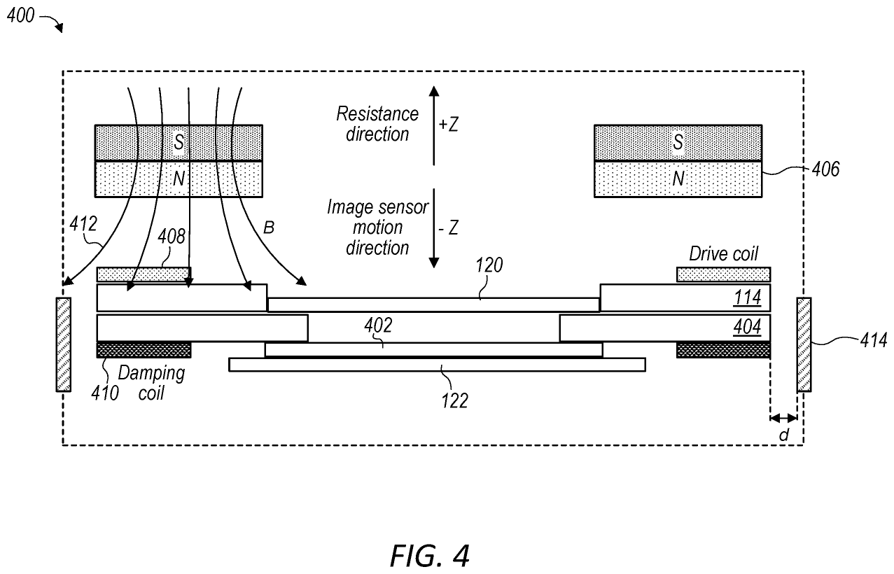

According to some embodiments, the camera system 100 may further include one or more motion damping arrangements in some embodiments. For example, the camera system 100 may include an electromagnetic-based motion damping arrangement (e.g., comprising one or more closed loop passive coils 118; also referred to herein as an “electromagnetic damping arrangement”) and/or an air-based motion damping arrangement (also referred to herein as an “air damping arrangement”), e.g., as discussed in further detail herein with reference to FIG. 4.

In various embodiments, the camera system 100 may include an optical filter 120 (e.g., an infrared cut-off filter (IRCF)), a stiffener 122, and/or a base structure 124. The optical filter 120 may be positioned above the image sensor 104, e.g., such that light passes through the optical filter 120 before it reaches the image sensor 104. The stiffener 122 may be positioned below the image sensor 104 and may provide structural support to the image sensor 104.

FIG. 2 illustrates a schematic side cross-sectional view of an example camera system 200 that includes a tilt actuator arrangement, in accordance with some embodiments. FIG. 2 includes an example Cartesian coordinate system for use as a reference aid in describing embodiments in the present disclosure.

The camera system 200 may include a lens group 202, an image sensor 204, the tilt actuator arrangement (e.g., comprising one or more voice coil motor (VCM) actuators), and a substrate 206. The tilt actuator arrangement may be used to tilt the image sensor 204, together with the substrate 206 (which may be fixedly coupled with the image sensor 204), relative to the lens group 202, e.g., to provide tilt compensation and/or optical image stabilization (OIS). In various embodiments, one or more of the components of the camera system 200 may be similar to, or the same as, one or more corresponding components of the camera system 100 (and/or other camera systems described herein).

As previously mentioned, the tilt actuator arrangement may comprise one or more VCM actuators. According to various embodiments, the VCM actuator(s) may include fixed drive magnets 208 that are fixedly coupled with a stationary component of the camera system 200. Furthermore, the VCM actuator(s) may include drive coils 210 that are fixedly coupled with the substrate 206.

According to various embodiments, each respective drive coil 210 may be positioned proximate a respective fixed drive magnet 208 such that, when driven with electric current, one or more of the drive coils 210 are capable of electromagnetically interacting with one or more of the fixed drive magnets 208 to tilt the image sensor 204 relative to the lens group 202. The VCM actuator(s) may be capable of tilting the image sensor 204 about multiple axes orthogonal to an optical axis (e.g., optical axis 112 in FIG. 1) of the camera system 200. In FIG. 2, double arrows 212 indicate, as a non-limiting example, that the image sensor 204 is tiltable about the Y-axis. However, the VCM actuator(s) may be capable of tilting the image sensor 204 about multiple axes along the X-Y plane, e.g., to compensate for “pitch” and “yaw” tilt/rotation (and/or to provide OIS) in various embodiments.

In various embodiments, the fixed drive magnets 208 may have a respective polarity along a vertical direction (e.g., the Z-axis direction) parallel to the optical axis. For example, as indicated in FIG. 2, each of the fixed drive magnets 208 may be oriented such that one pole (e.g., south magnetic pole S) is disposed above the other pole (e.g., north magnetic pole N) in the vertical direction.

FIG. 3 illustrates a schematic side cross-sectional view of an example camera system 300 that includes an autofocus (AF) actuator arrangement, in accordance with some embodiments. The camera system 300 may include a lens group 302, an image sensor 304, the AF actuator arrangement (e.g., comprising one or more voice coil motor (VCM) actuators), and a substrate 306. The AF actuator arrangement may be used to move/shift the image sensor 304, together with the substrate 306 (which may be fixedly coupled with the image sensor 304), relative to the lens group 302, e.g., to provide AF. In various embodiments, one or more of the components of the camera system 300 may be similar to, or the same as, one or more corresponding components of camera system 100 (and/or other camera systems described herein).

As previously mentioned, the AF actuator arrangement may comprise one or more VCM actuators. According to various embodiments, the VCM actuator(s) may include fixed drive magnets 308 that are fixedly coupled with a stationary component of the camera system 300. Furthermore, the VCM actuator(s) may include drive coils 310 that are fixedly coupled with the substrate 306.

According to various embodiments, each respective drive coil 310 may be positioned proximate a respective fixed drive magnet 308 such that, when driven with electric current, one or more of the drive coils 310 are capable of electromagnetically interacting with one or more of the fixed drive magnets 308 to move the image sensor 304 in at least one direction parallel to an optical axis (e.g., optical axis 112 in FIG. 1) of the camera system 300. In FIG. 2, double arrows 312 indicate that the image sensor 304 is movable in the Z-axis direction(s) to adjust focus. For example, VCM actuator(s) may be capable of moving the image sensor 304 upward (+Z-axis direction) toward the lens group 302. Furthermore, the VCM actuator(s) may be capable of moving the image sensor 304 downward (−Z-axis direction) away from the lens group 302.

In various embodiments, the fixed drive magnets 308 may have a respective polarity along a vertical direction (e.g., the Z-axis direction) parallel to the optical axis. For example, as indicated in FIG. 3, each of the fixed drive magnets 308 may be oriented such that one pole (e.g., south magnetic pole S) is disposed above the other pole (e.g., north magnetic pole N) in the vertical direction.

According to various embodiments, the camera system 300 may include a housing (e.g., a shield can 314). In some embodiments, the housing may include multiple portions. For example, in the non-limiting example shown in FIG. 3, the shield can 314 may include an upper shield can portion 314a and a lower shield can portion 314b. The upper shield can portion 314a may encase an upper portion of the camera system 300. The lower shield can portion 314b may encase a lower portion of the camera system 300. The upper shield can portion 314a and the lower shield can portion 314b may overlap in some embodiments, e.g., as indicated in FIG. 3. The upper shield can portion 314a may be attached (e.g., at the overlapping portion) to the lower shield can portion 314b.

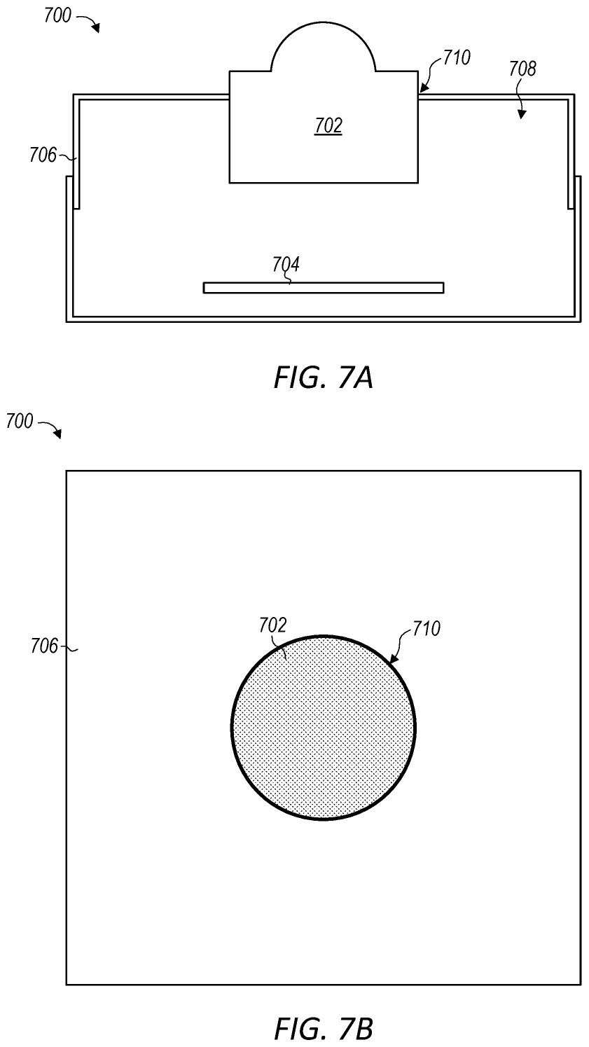

As also discussed herein with reference to FIGS. 4 and 7A-7B, internal components of the camera system 300 may be protected from particle ingression, which may damage the camera system 300 and/or degrade image quality. For example, an interface between the lens group 302 and the shield can 314 may form a seal (or otherwise mitigate particle exposure to the internal components). In some embodiments, the internal components of the camera system 300 may be fully encased and/or sealed off from external particles.

FIG. 4 illustrates a schematic side cross-sectional view of an example camera system 400 that includes one or more motion damping arrangements, in accordance with some embodiments. For example, the camera system 400 may include an electromagnetic damping arrangement and/or an air damping arrangement in various embodiments.

The camera system 400 may include a lens group (e.g., lens group 302 in FIG. 3 and/or other lens groups described herein), an image sensor 402, one or more voice coil motor (VCM) actuators, and a substrate 404. In various embodiments, one or more of the components of the camera system 400 may be similar to, or the same as, one or more corresponding components of camera system 100 (and/or other camera systems described herein).

The VCM actuator(s) may include a tilt actuator (e.g., as described herein with reference to FIG. 2) and/or an autofocus actuator (e.g., as described herein with reference to FIG. 3). In various embodiments, the VCM actuator(s) may include fixed drive magnets 406 that are fixedly coupled with a stationary component of the camera system 400. Furthermore, the VCM actuator(s) may include drive coils 408 that are fixedly coupled with the substrate 404.

In various embodiments, the fixed drive magnets 406 may have a respective polarity along a vertical direction (e.g., the Z-axis direction) parallel to an optical axis (e.g., optical axis 112 in FIG. 1) of the camera system 400. For example, as indicated in FIG. 4, each of the fixed drive magnets 406 may be oriented such that one pole (e.g., south magnetic pole S) is disposed above the other pole (e.g., north magnetic pole N) in the vertical direction. As indicated by magnetic field arrows B in FIG. 4, this vertical polarity orientation produces a magnetic flux gradient along the vertical direction.

In some embodiments, the electromagnetic damping arrangement may include one or more damping coils 410 (e.g., closed loop passive coil(s)). The damping coil(s) 410 may be fixedly coupled with the substrate 404, e.g., as indicated in FIG. 4.

In various embodiments, each damping coil 410 may be positioned relative to a fixed drive magnet 406 such that, when there is relative motion between the fixed drive magnet 406 caused by motion of the substrate 404, the fixed drive magnet 406 induces a current in the damping coil 410. The induced current may produce a magnetic field that opposes the motion of the substrate 404 due to Lenz's law, thereby providing electromagnetic damping. The magnitude of the electromagnetic damping may be proportional to the speed of the motion. As the electromagnetic damping is completely passive, no drive current needs to be routed to or provided to the damping coil(s) 410.

In the non-limiting example shown in FIG. 4, image sensor motion direction arrow −Z indicates a downward motion of the substrate 404 (along with components coupled with the substrate 404, such as the image sensor 402 and the damping coil(s) 410) away from fixed drive magnets 406. In accordance with Lenz's law, a magnetic field that opposes the −Z motion is produced, e.g., as indicated by resistance direction arrow +Z. In FIG. 4, arrow +Z and arrow −Z are used to indicate direction (not magnitude). In some embodiments, the image sensor motion may be in the +Z direction, and the resistance due to electromagnetic damping may be in the −Z direction.

In some embodiments, each respective damping coil 410 may be vertically aligned with a respective fixed drive magnet 406. Additionally, or alternatively, the damping coil(s) 410 and the drive coils 408 may be on opposite sides of the substrate 404. For example, a drive coil 408 may be on a first side of the substrate 404. A damping coil 410 may be on second side of the substrate 404. The first side of the substrate and the second side of the substrate may face in opposite directions.

According to various embodiments, the camera system 400 may include multiple damping coils 410. For example, the damping coils 410 may be corner damping coils 410 in some embodiments. Each respective corner damping coil 410 may be positioned proximate a respective corner of the camera system 400.

In some embodiments, the damping coils 410 may include a first damping coil, a second damping coil, a third damping coil, and a fourth damping coil. A first axis parallel to the optical axis may intersect a first fixed drive magnet, an area within an outer periphery of a first drive coil, and an area within an outer periphery of the first damping coil. A second axis parallel to the optical axis may intersect a second fixed drive magnet, an area within an outer periphery of a second drive coil, and an area within an outer periphery of the second damping coil. A third axis parallel to the optical axis may intersect a third fixed drive magnet, an area within an outer periphery of a third drive coil, and an area within an outer periphery of the third damping coil. A fourth axis parallel to the optical axis may intersect a fourth fixed drive magnet, an area within an outer periphery of a fourth drive coil, and an area within an outer periphery of the fourth damping coil.

In some embodiments, the air damping arrangement may include the camera system 400 being sealed and further designed so that one or more movable components push air within the camera system 400 when in motion, causing air resistance. For example, as indicated schematically in FIG. 4, the camera system 400 may include a sealed environment, e.g., including a housing 414 such as a shield can. As also discussed herein with reference to FIGS. 7A-7B, a portion of the sealed environment may include a sealed interface between the housing 414 and a lens group (e.g., lens group 702 in FIG. 7A; not shown in FIG. 4). In various embodiments, a desired amount of air damping may be achieved based at least in part on a size of the substrate 404, a size of the housing 414, and/or a size of a gap (e.g., indicated as having a distance d in FIG. 4) between the substrate 404 and the housing 414.

In some embodiments, the substrate 404 may not be the longest (in the X-axis direction) component that is coupled and movable with the image sensor 402. In such cases, the desired amount of air damping may be achieved based at least in part on a gap between the longest component and the housing 414. For example, the gap may be a shortest distance, in the X-axis direction, from an outermost vertical surface of the longest component to an innermost vertical surface of the housing 414.

In non-limiting example shown in FIG. 4, the lens group and the drive magnets are fixed, and the image sensor (along with the substrate) and the drive coils are movable. However, it should be understood that the motion damping arrangements described herein may be used in camera systems that are configured differently, e.g., a camera system having a movable lens group and a fixed image sensor, and/or a camera system having fixed drive coils and movable drive magnets, etc.

For example, a camera system may include a lens group, an image sensor, a moveable carrier coupled with the lens group of the image sensor, one or more VCM actuators, and one or more closed loop passive coils. The VCM actuator(s) may include one or more drive magnets and one or more drive coils. Each respective drive coil may be positioned proximate a respective drive magnet such that, when driven with electric current, the respective drive coil is capable of electromagnetically interacting with the respective drive magnet to move the moveable carrier in at least one direction.

Each respective closed loop passive coil may be positioned relative to a respective drive magnet such that, when there is relative motion between the drive magnet and the respective closed loop passive coil caused by motion of the movable carrier, the respective drive magnet induces a current in the respective closed loop passive coil. The induced current produces a magnetic field that opposes the motion of the moveable carrier, thereby providing electromagnetic damping.

The moveable carrier may have an outer periphery, along a plane orthogonal to the optical axis, that is spaced apart, along the plane, from an inner surface of the shield can by a gap distance. The gap distance may be sized based on a predetermined amount of desired air damping provided by resistance from the moveable carrier pushing air during motion. The resistance may increase as the gap distance decreases in differently sized camera systems.

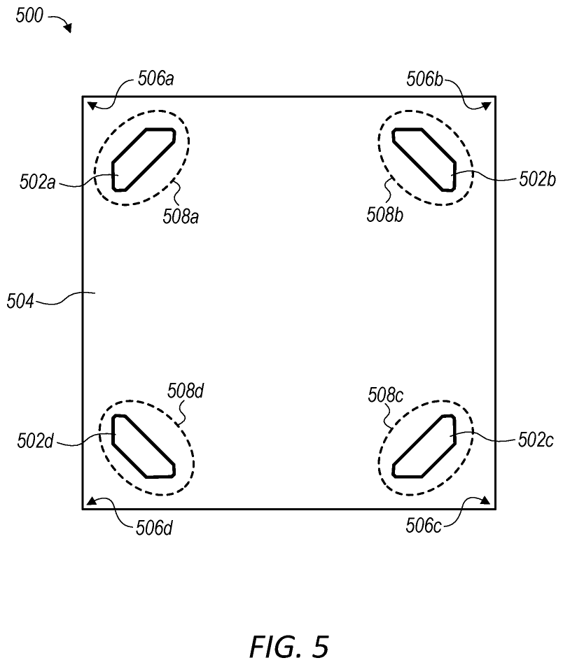

FIG. 5 illustrates a schematic view of an example fixed drive magnet arrangement 500 relative to an underside of a housing (e.g., a shield can), in accordance with some embodiments. The fixed drive magnet arrangement 500 may include fixed drive magnets 502 that are fixedly coupled with the housing 504. In various embodiments, the fixed drive magnets 502 may be corner drive magnets, each of which is fixedly coupled with the housing 504 at a respective corner of an underside of the housing 504.

In some non-limiting embodiments, the fixed drive magnets 502 may include a first fixed drive magnet 502a, a second fixed drive magnet 502b, a third fixed drive magnet 502c, and a fourth fixed drive magnet 502d. The underside of the housing 504 may include a first corner 506a, a second corner 506b, a third corner 506c, and a fourth corner 506d. The first fixed drive magnet 502a may be disposed at a first corner area 508a proximate the first corner 506a. The second fixed drive magnet 502b may be disposed at a second corner area 508b proximate the second corner 506b. The third fixed drive magnet 502c may be disposed at a third corner area 508c proximate the third corner 506c. The fourth fixed drive magnet 502d may be disposed at a fourth corner area 508d proximate the fourth corner 506d.

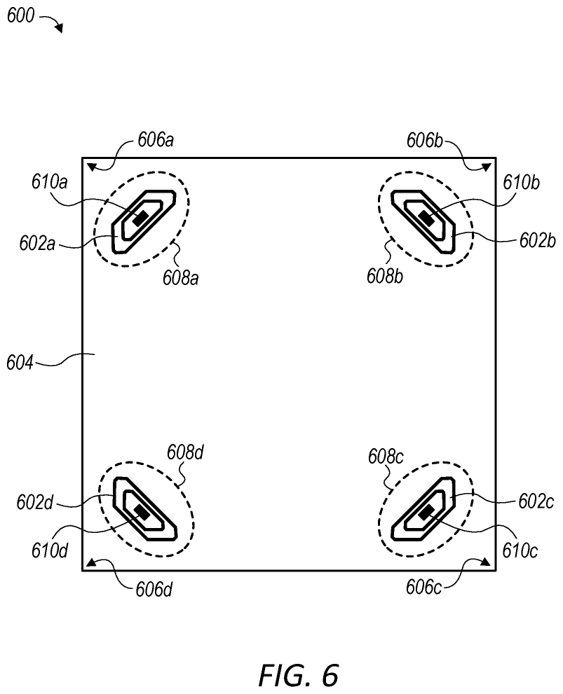

FIG. 6 illustrates a schematic view of an example drive coil arrangement 600 relative to upper surface of a substrate, in accordance with some embodiments. The drive coil arrangement 600 may include drive coils 602 that are fixedly coupled with the substrate 604. In various embodiments, the drive coils 602 may be corner drive coils, each of which is fixedly coupled with the substrate 604 at a respective corner of an upper surface of the substrate 604.

In some non-limiting embodiments, the drive coils 602 may include a first drive coil 602a, a second drive coil 602b, a third drive coil 602c, and a fourth drive coil 602d. The upper surface of the substrate 604 may include a first corner 606a, a second corner 606b, a third corner 606c, and a fourth corner 606d. The first drive coil 602a may be disposed at a first corner area 608a proximate the first corner 606a. The second drive coil 602b may be disposed at a second corner area 608b proximate the second corner 606b. The third drive coil 602c may be disposed at a third corner area 608c proximate the third corner 606c. The fourth drive coil 602d may be disposed at a fourth corner area 608d proximate the fourth corner 606d.

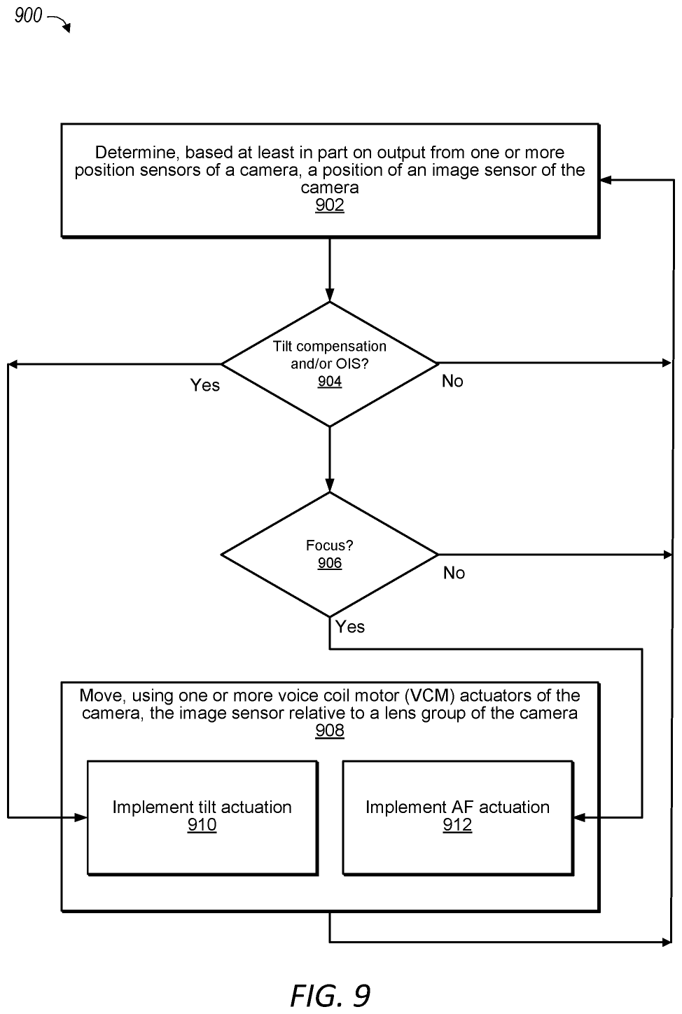

According to some embodiments, a camera system (e.g., camera system 100 in FIG. 1 and/or other camera systems described herein) may include one or more position sensors 610. The position sensor(s) 610 may be used for determining a position of an image sensor (e.g., image sensor 104 in FIG. 1 and/or other image sensors described herein) coupled with the substrate 604. For example, a current position of the image sensor may be determined based at least in part on output from the position sensor(s) 610, and the current position may be used to determine whether the position of the image sensor should be adjusted (e.g., via tilt actuation and/or AF actuation, as also indicated herein with reference to FIG. 9) to a target position. The output from the position sensor(s) 610 may be based at least in part on one or more magnetic fields (e.g., produced by fixed drive magnets) sensed by the position sensor(s) 610.

In various non-limiting embodiments, each respective position sensor 610 may be encircled by a respective drive coil 602. In some non-limiting embodiments, the position sensor(s) 610 may include a first position sensor 610a, a second position sensor 610b, a third position sensor 610c, and a fourth position sensor 610d. As previously mentioned, the substrate 604 may include corner areas 608. In some embodiments, the first position sensor 610a may be disposed at the first corner area 608a proximate the first corner 606a. The second position sensor 610b may be disposed at the second corner area 608b proximate the second corner 606b. The third position sensor 610c may be disposed at the third corner area 608c proximate the third corner 606c. The fourth position sensor 610d may be disposed at the fourth corner area 608d proximate the fourth corner 606d. Additionally, or alternatively, each respective position sensor 610 may be positioned proximate a respective fixed drive magnet (e.g., fixed drive magnets 106 and/or other fixed drive magnets described herein) so that it is capable of detecting the magnetic field of the respective fixed drive magnet.

As indicated in FIG. 6, each respective position sensor 610 may be encircled by a respective drive coil 602 in some embodiments. For example, the first drive coil 602a may encircle the first position sensor 610a. The second drive coil 602b may encircle the second position sensor 610b. The third drive coil 602c may encircle the third position sensor 610c. The fourth drive coil 602d may encircle the fourth position sensor 610d.

FIGS. 7A-7B illustrate views of an example camera system 700 having an interior portion that is completely encased, in accordance with some embodiments. FIG. 7A shows a schematic side cross-sectional view of the camera system 700. FIG. 7B shows a schematic top view of the camera system 700. The camera system 700 may include a lens group 702 an image sensor 704, and a housing 706 (e.g., comprising a shield can). In various embodiments, one or more of the components of the camera system 700 may be similar to, or the same as, one or more corresponding components of camera system 100 (and/or other camera systems described herein).

According to various embodiments, an interior portion 708 may be entirely encased such that interior components (disposed within the interior portion) are protected from particle ingression. Particles from the exterior environment (e.g., external to the camera system 700) may degrade image quality and/or camera performance if allowed to enter the interior portion 708 of the camera system 700. For example, if such particles were to reach the image sensor 704, the image quality may be negatively impacted. The camera system 700 being entirely encased may mitigate particle ingression and thus protect the image sensor 704 (and/or other interior components) from particles.

In various embodiments, an interface 710 between the lens group 702 and the housing 706 may form a seal in the sense that the interface 710 may mitigate particle ingression between the lens group 702 and the housing 706. Some other camera systems may include a gap between the lens group and the housing, e.g., to allow for lens group motion for AF and/or OIS. Such a gap provides an open area through which particles may enter those camera systems. By contrast, camera systems described herein may be designed to move the image sensor (rather than the lens group) to implement AF, tilt correction, and/or OIS, thus allowing for a fixed/stationary lens group and eliminating the previously mentioned gap requirement of some other camera systems.

In various embodiments, the camera system 700 being sealed as described herein may provide an opportunity for air damping, e.g., as discussed herein with reference to FIG. 4. By completely encasing the interior portion 708, air within the interior portion 708 must remain within the camera system 700 and can be utilized to provide air resistance to image sensor motion, thereby enabling air-based motion damping.

FIGS. 8A-8B illustrate views of an example sensor shift suspension arrangement 800 (e.g., a flexure-based sensor shift suspension arrangement) of a camera system (e.g., camera system 100 in FIG. 1 and/or other camera systems described herein) that may include a tilt actuator, an AF actuator, and/or one or more damping arrangements, in accordance with some embodiments. FIG. 8A shows a schematic side cross-sectional view of the sensor shift suspension arrangement 800 including a flexure 802. FIG. 8B shows a schematic top view of the flexure 802.

In some embodiments, the sensor shift suspension arrangement 800 may include the flexure 802, which may be configured to suspend an image sensor 804 (which may be fixedly coupled with a substrate 806) from one or more stationary components 808 (e.g., a base structure of the camera system) and allow motion of the image sensor 804 enabled by one or more voice coil motor (VCM) actuators of the camera system. According to various embodiments, the flexure 802 may include an inner frame 810, an outer frame 812, and one or more flexure arms 814. The inner frame 810 may be coupled with the substrate 806. The outer frame 812 may be coupled with the stationary component(s) 808. The flexure arm(s) 814 may extend from the inner frame 810 to the outer frame 812.

In FIG. 8B, the flexure 802 includes four flexure arms 814 which are schematically represented. It should be understood, however, that the number and arrangement of the flexure arms 814 may be different in various embodiments. The flexure 802 and/or the flexure arms 814 may be configured to provide sufficient stiffness to suspend the image sensor 804 from the stationary structure(s) 806 and avoid undesired motion, while also providing sufficient compliance to enable intended motion caused by the VCM actuator(s).

In some embodiments, the flexure 802 and/or the sensor shift suspension arrangement 800 may be used to route/convey electrical signals between components of the camera system. Such electrical signals may include, for example, image signals, power signals, and/or drive signals, etc. Electrical signals may be conveyed between the stationary component(s) 808 and the image sensor 804 via the flexure 802 and the substrate 806 in some embodiments. For example, electrical signals may be conveyed from the stationary component(s) 808 to the outer frame 812, then from the outer frame 812 to the inner frame 810 via electrical traces (not shown) on the flexure arm(s) 814, then from the inner frame 810 to the substrate 806, and then from the substrate 806 to the image sensor 804. The same path may be taken in reverse to convey electrical signals from the image sensor 804 to the stationary component(s) 808 in some embodiments.

FIG. 9 is a flowchart that illustrates an example method 900 of operating a camera system that is capable of implementing tilt actuation and/or autofocus (AF) actuation, in accordance with some embodiments.

At 902, the method 900 may include determining a position of an image sensor of a camera. For example, the position of the image sensor may be determined based at least in part on output from one or more position sensors of the camera, e.g., as also discussed herein with reference to FIG. 6.

At 904, the method 900 may include determining whether tilt compensation and/or OIS motion is triggered. For example, a current position of the image sensor may be compared with a target tilt/OIS position of the image sensor. If the current position of the image sensor is different from the target tilt/OIS position, then it may be determined that tilt compensation and/or OIS motion is triggered. In some implementations, determining whether tilt compensation and/or OIS motion is triggered may include determining whether the current position of the image sensor is within a threshold value of the target tilt/OIS position.

At 906, the method 900 may include determining whether focus (e.g., AF) motion is triggered. For example, a current position of the image sensor may be compared with a target focus position of the image sensor. If the current position of the image sensor is different from the target focus position, then it may be determined that AF motion is triggered. In some implementations, determining whether AF motion is triggered may include determining whether the current position of the image sensor is within a threshold value of the target focus position.

If it is determined, at 904 and/or 906, that tilt compensation, OIS, and/or AF motion is triggered, then the method 900 may include moving, using one or more voice coil motor (VCM) actuators of the camera, the image sensor relative to a lens group of the camera (at 908). Moving the image sensor may include providing (e.g., via a controller) an electric current to at least one of the drive coils of the VCM actuator(s). For example, if, at 904, it is determined that tilt compensation and/or OIS motion is triggered, then the method 900 may include implementing tilt actuation (at 910), e.g., as discussed herein with reference to FIG. 2. In some examples, implementing tilt actuation may include independently driving one or more of the drive coils to tilt the image sensor, together with the substrate, about an axis orthogonal to the optical axis. The VCM actuator(s) may be capable of tilting the image sensor about multiple axes.

Additionally, or alternatively, if, at 906, it is determined that AF motion is triggered, then the method 900 may include implementing AF actuation (at 912), e.g., as discussed herein with reference to FIG. 3. In some examples, implementing AF actuation may include providing electric current to multiple ones of the drive coils to move the image sensor, together with the substrate, in at least one direction parallel to the optical axis.

In various implementations, the method 900 may include continuously and/or periodically determining the current position of the image sensor (at 902), then checking whether tilt compensation, OIS, and/or AF motion is triggered (at 904 and 906), etc.

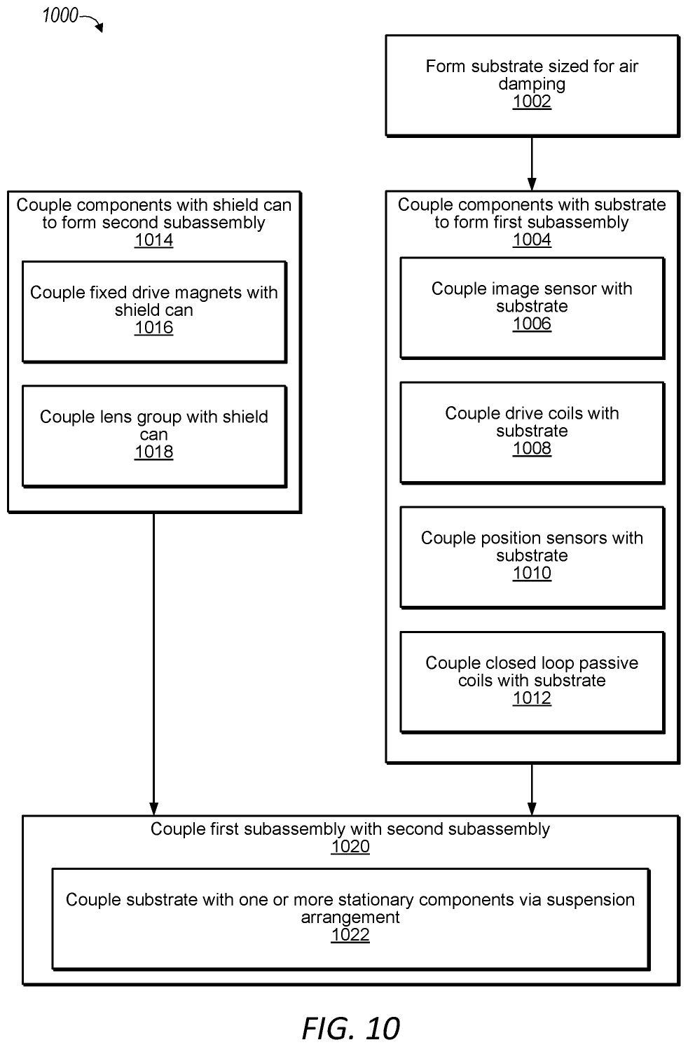

FIG. 10 is a flowchart that illustrates an example process 1000 of assembling, at least in part, a camera system that is capable of implementing tilt actuation, autofocus (AF) actuation, and/or motion damping, in accordance with some embodiments.

At 1002, the process 1000 may include forming a substrate sized for air damping. As discussed herein with reference to FIG. 4, a desired amount of air damping may be achieved based at least in part on a size of the substrate, a size of the housing, and/or a size of a gap (e.g., indicated as having a distance d in FIG. 4) between the substrate and the housing. Air damping is also discussed herein with reference to FIGS. 7A-7B.

At 1004, the process 1000 may include coupling components with the substrate to form a first subassembly. For example, at 1006, the process 1000 may include coupling an image sensor with the substrate. At 1008, the process 1000 may include coupling drive coils with the substrate. The drive coils may be part of one or more voice coil motor (VCM) actuators of the camera system. At 1010, the process 1000 may include coupling position sensors with the substrate. At 1012, the process 1000 may include coupling closed loop passive coils with the substrate. FIGS. 1-4, 6, 8A-8B and their corresponding written description indicate examples of components that may be coupled with the substrate and their relative positioning in some non-limiting embodiments.

At 1014, the process 1000 may include coupling components with a shield can to form a second subassembly. For example, at 1016, the process 1000 may include coupling fixed drive magnets with the shield can. The fixed drive magnets may be part of the VCM actuator(s) of the camera system. At 1018, the process 1000 may include coupling a lens group with the shield can. For example, the lens group may be coupled with the shield can using an adhesive. As discussed herein with reference to FIGS. 7A-7B, an interface between the lens group and the shield can may form a seal in the sense that the interface may mitigate particle ingression between the lens group and the shield can.

At 1020, the process 1000 may include coupling the first subassembly (formed at 1004) with the second subassembly (formed at 1014). In some implementations, coupling the first subassembly with the second subassembly may include coupling the substrate with one or more stationary components (e.g., a base structure coupled with the shield can) via a suspension arrangement (at 1022). For example, as discussed herein with reference to FIGS. 8A-8B, the suspension arrangement may include a flexure, which may be configured to suspend the image sensor from the stationary component(s) and allow motion of the image sensor enabled by the VCM actuator(s).

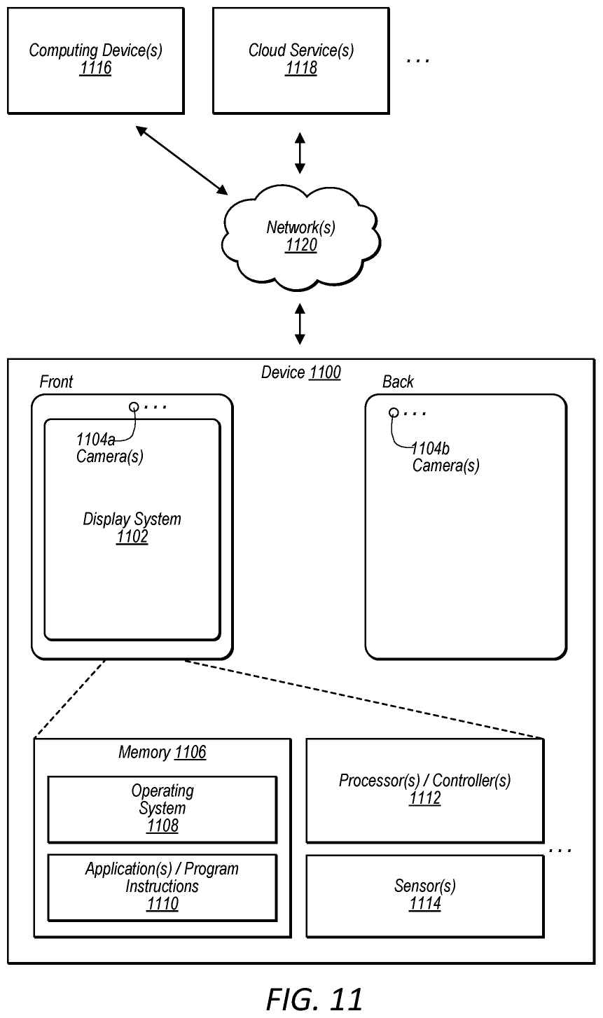

FIG. 11 illustrates a schematic representation of an example environment comprising a device 1100 that may include one or more cameras. For example, the device 1100 may include a camera system with a tilt actuator, an AF actuator, and/or one or more damping arrangements, e.g., as described herein with reference to FIGS. 1A-10. In some embodiments, the device 1100 may be a mobile device and/or a multifunction device. In various embodiments, the device 1100 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1100 may include a display system 1102 (e.g., comprising a display and/or a touch-sensitive surface) and/or one or more cameras 1104. In some non-limiting embodiments, the display system 1102 and/or one or more front-facing cameras 1104a may be provided at a front side of the device 1100, e.g., as indicated in FIG. 11. Additionally, or alternatively, one or more rear-facing cameras 1104b may be provided at a rear side of the device 1100. In some embodiments comprising multiple cameras 1104, some or all of the cameras 1104 may be the same as, or similar to, each other. Additionally, or alternatively, some or all of the cameras 1104 may be different from each other. In various embodiments, the location(s) and/or arrangement(s) of the camera(s) 1104 may be different than those indicated in FIG. 11.

Among other things, the device 1100 may include memory 1106 (e.g., comprising an operating system 1108 and/or application(s)/program instructions 1110), one or more processors and/or controllers 1112 (e.g., comprising CPU(s), memory controller(s), display controller(s), and/or camera controller(s), etc.), and/or one or more sensors 1114 (e.g., orientation sensor(s), proximity sensor(s), and/or position sensor(s), etc.). In some embodiments, the device 1100 may communicate with one or more other devices and/or services, such as computing device(s) 1116, cloud service(s) 1118, etc., via one or more networks 1120. For example, the device 1100 may include a network interface (e.g., network interface 710 in FIG. 7) that enables the device 1100 to transmit data to, and receive data from, the network(s) 1120. Additionally, or alternatively, the device 1100 may be capable of communicating with other devices via wireless communication using any of a variety of communications standards, protocols, and/or technologies.

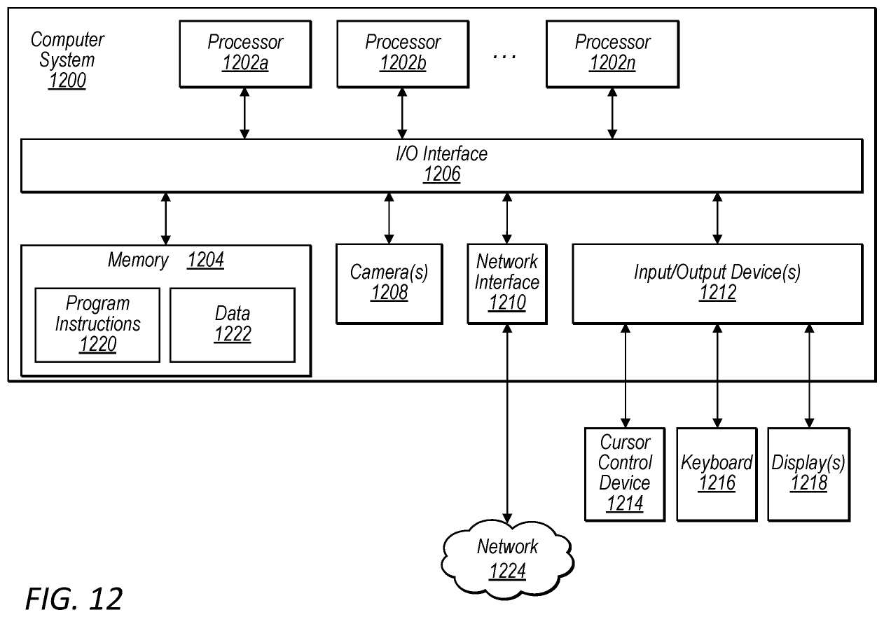

FIG. 12 illustrates a schematic block diagram of an example environment comprising a computer system 1200 that may include a camera system with a tilt actuator, an AF actuator, and/or one or more damping arrangements, e.g., as described herein with reference to FIGS. 1A-11. In addition, computer system 1200 may implement methods for controlling operations of the camera and/or for performing image processing on images captured with the camera. In some embodiments, the device 1100 (described herein with reference to FIG. 11) may additionally, or alternatively, include some or all of the functional components of the described herein.

The computer system 1200 may be configured to execute any or all of the embodiments described above. In different embodiments, computer system 1200 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1200 includes one or more processors 1202 coupled to a system memory 1204 via an input/output (I/O) interface 1206. Computer system 1200 further includes one or more cameras 1208 coupled to the I/O interface 1206. Computer system 1200 further includes a network interface 1210 coupled to I/O interface 1206, and one or more input/output devices 1212, such as cursor control device 1214, keyboard 1216, and display(s) 1218. In some cases, it is contemplated that embodiments may be implemented using a single instance of computer system 1200, while in other embodiments multiple such systems, or multiple nodes making up computer system 1200, may be configured to host different portions or instances of embodiments. For example, in one embodiment some elements may be implemented via one or more nodes of computer system 1200 that are distinct from those nodes implementing other elements.

In various embodiments, computer system 1200 may be a uniprocessor system including one processor 1202, or a multiprocessor system including several processors 1202 (e.g., two, four, eight, or another suitable number). Processors 1202 may be any suitable processor capable of executing instructions. For example, in various embodiments processors 1202 may be general-purpose or embedded processors implementing any of a variety of instruction set architectures (ISAs), such as the x86, PowerPC, SPARC, or MIPS ISAs, or any other suitable ISA. In multiprocessor systems, each of processors 1202 may commonly, but not necessarily, implement the same ISA.

System memory 1204 may be configured to store program instructions 1220 accessible by processor 1202. In various embodiments, system memory 1204 may be implemented using any suitable memory technology, such as static random access memory (SRAM), synchronous dynamic RAM (SDRAM), nonvolatile/Flash-type memory, or any other type of memory. Additionally, existing camera control data 1222 of memory 1204 may include any of the information or data structures described above. In some embodiments, program instructions 1220 and/or data 1222 may be received, sent or stored upon different types of computer-accessible media or on similar media separate from system memory 1204 or computer system 1200. In various embodiments, some or all of the functionality described herein may be implemented via such a computer system 1200.

In one embodiment, I/O interface 1206 may be configured to coordinate I/O traffic between processor 1202, system memory 1204, and any peripheral devices in the device, including network interface 1210 or other peripheral interfaces, such as input/output devices 1212. In some embodiments, I/O interface 1206 may perform any necessary protocol, timing or other data transformations to convert data signals from one component (e.g., system memory 1204) into a format suitable for use by another component (e.g., processor 1202). In some embodiments, I/O interface 1206 may include support for devices attached through various types of peripheral buses, such as a variant of the Peripheral Component Interconnect (PCI) bus standard or the Universal Serial Bus (USB) standard, for example. In some embodiments, the function of I/O interface 1206 may be split into two or more separate components, such as a north bridge and a south bridge, for example. Also, in some embodiments some or all of the functionality of I/O interface 1206, such as an interface to system memory 1204, may be incorporated directly into processors 1202.

Network interface 1210 may be configured to allow data to be exchanged between computer system 1200 and other devices attached to a network 1224 (e.g., carrier or agent devices) or between nodes of computer system 1200. Network 1224 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1210 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output device(s) 1212 may, in some embodiments, include one or more display terminals, keyboards, keypads, touchpads, scanning devices, voice or optical recognition devices, or any other devices suitable for entering or accessing data by one or more computer systems 1200. Multiple input/output devices 1212 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1210.

Those skilled in the art will appreciate that computer system 1200 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1200 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1200 may be transmitted to computer system 1200 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

Additional descriptions of embodiments (example clauses):

Clause 1: A camera, comprising: a lens group; an image sensor; one or more voice coil motor (VCM) actuators, comprising: fixed drive magnets; and drive coils; and a substrate coupled with the image sensor and with the drive coils, wherein each respective drive coil is positioned proximate a respective fixed drive magnet such that, when driven with electric current, one or more of the drive coils are capable of electromagnetically interacting with one or more of the fixed drive magnets to tilt the image sensor relative to the lens group, and wherein the one or more VCM actuators are capable of tilting the image sensor about multiple axes orthogonal to an optical axis of the camera.

Clause 2: The camera of Clause 1, wherein each of the fixed drive magnets has a respective polarity along a vertical direction parallel to the optical axis.

Clause 3: The camera of Clause 1 or Clause 2, wherein the drive coils comprise: a first drive coil capable of being driven with a first respective drive current; a second drive coil capable of being driven with a second respective drive current; a third drive coil capable of being driven with a third respective drive current; and a fourth drive coil capable of being driven with a fourth respective drive current.

Clause 4: The camera of Clause 3, wherein, when using the one or more VCM actuators to tilt the image sensor, the first respective drive current is different than at least one of: the respective second drive current; the respective third drive current; or the respective fourth drive current.

Clause 5: The camera of any one of Clauses 1-4, wherein the fixed drive magnets are corner drive magnets, wherein each corner drive magnet is positioned proximate a respective corner of the camera; the drive coils are corner drive coils, wherein each corner drive coil is positioned proximate a respective corner of the camera; and each respective corner drive coil is positioned, in a respective axis parallel to the optical axis, between a respective corner drive magnet and the substrate.

Clause 6: The camera of any one of Clauses 1-5, wherein the lens group comprises one or more glass lens elements; and the lens group is fixedly coupled with a stationary component of the camera.

Clause 7: The camera of Clause 6, wherein the stationary component is a shield can of the camera.

Clause 8: The camera of any one of Clauses 1-7, wherein, when driven with electric current, the drive coils are further capable of electromagnetically interacting with the fixed drive magnets to move the image sensor in at least one direction parallel to the optical axis.

Clause 9: A device, comprising: one or more processors; memory storing program instructions executable by the one or more processors to control operations of a camera; and the camera, comprising: a lens group; an image sensor; one or more voice coil motor (VCM) actuators, comprising: fixed drive magnets; and drive coils; and a substrate coupled with the image sensor and with the drive coils, wherein each respective drive coil is positioned proximate a respective fixed drive magnet such that, when driven with electric current, one or more of the drive coils are capable of electromagnetically interacting with one or more of the fixed drive magnets to tilt the image sensor relative to the lens group, and wherein the one or more VCM actuators are capable of tilting the image sensor about multiple axes orthogonal to an optical axis of the camera.

Clause 10: The device of Clause 9, wherein each of the fixed drive magnets has a respective polarity along a vertical direction parallel to the optical axis.

Clause 11: The device of Clause 9 or Clause 10, wherein each of the drive coils is capable of being independently driven.

Clause 12: The device of any one of Clauses 9-11, wherein the drive coils are oriented such that, when driven with an electric current, the electric current flows along multiple directions orthogonal to the optical axis.

Clause 13: The device of any one of Clauses 9-12, wherein the camera further comprises: position sensors, wherein each respective position sensor is encircled by a respective drive coil.

Clause 14: The device of any one of Clauses 9-13, wherein, when driven with electric current, the drive coils are further capable of electromagnetically interacting with the fixed drive magnets to move the image sensor in at least one direction parallel to the optical axis.

Clause 15: The device of any one of Clauses 9-14, wherein the camera further comprises: a closed loop passive coil coupled with the substrate and positioned relative to a fixed drive magnet of the fixed drive magnets such that, when there is relative motion between fixed drive magnet and the closed loop passive coil caused by motion of the substrate, the fixed drive magnet induces a current in the closed loop passive coil, wherein the current produces a magnetic field that opposes the motion of the substrate, thereby providing electromagnetic damping.

Clause 16: The device of any one of Clauses 9-15, wherein the camera further comprises: an encasing that provides a sealed environment for an interior portion of the camera, wherein the sealed environment protects the interior portion from particle ingression, and wherein the encasing comprises: a shield can; and a sealed interface between the lens group and the shield can, wherein the lens group is fixedly attached to the shield can.

Clause 17: A system, comprising: an image sensor; a substrate coupled with the image sensor; and drive coils, of one or more voice coil motor (VCM) actuators of a camera, coupled with the substrate, wherein each respective drive coil is positioned proximate a respective fixed drive magnet of the one or more VCM actuators such that, when driven with electric current, one or more of the drive coils are capable of electromagnetically interacting with one or more of the fixed drive magnets to tilt the image sensor, and wherein the one or more VCM actuators are capable of tilting the image sensor about multiple axes orthogonal to an optical axis of the camera.

Clause 18: The system of Clause 17, wherein, when driven with electric current, the drive coils are further capable of electromagnetically interacting with the fixed drive magnets to move the image sensor in at least one direction parallel to the optical axis.

Clause 19: The system of Clause 17 or Clause 18, further comprising: a closed loop passive coil coupled with the substrate and positioned relative to a fixed drive magnet of the fixed drive magnets such that, when there is relative motion between fixed drive magnet and the closed loop passive coil caused by motion of the substrate, the fixed drive magnet induces a current in the closed loop passive coil, wherein the current produces a magnetic field that opposes the motion of the substrate, thereby providing electromagnetic damping.

Clause 20: The system of any one of Clauses 17-19, further comprising: a flexure that suspends the substrate and that allows motion of the substrate enabled by the one or more VCM actuators, wherein the flexure comprises: an inner frame coupled with the substrate; an outer frame coupled with one or more stationary components of the camera; and one or more flexure arms that extend from the inner frame to the outer frame.

Clause 21: A camera, comprising: a lens group; an image sensor; one or more voice coil motor (VCM) actuators, comprising: fixed drive magnets, wherein each of the fixed drive magnets has a polarity along a vertical direction parallel to an optical axis of the camera; and drive coils; and a substrate coupled with the image sensor and with the drive coils, wherein each respective drive coil is positioned proximate a respective fixed drive magnet such that, when driven with electric current, one or more of the drive coils are capable of electromagnetically interacting with one or more of the fixed drive magnets to move the image sensor, together with the substrate, relative to the lens group.

Clause 22: The camera of Clause 21, wherein the one or more VCM actuators are capable of moving the image sensor in at least one direction parallel to the optical axis.

Clause 23: The camera of Clause 21 or Clause 22, wherein the one or more VCM actuators are further capable of tilting the image sensor about multiple axes orthogonal to the optical axis.

Clause 24: The camera of any one of Clauses 21-23, wherein: the fixed drive magnets are corner drive magnets, wherein each corner drive magnet is positioned proximate a respective corner of the camera; the drive coils are corner drive coils, wherein each corner drive coil is positioned proximate a respective corner of the camera; and each respective corner drive coil is positioned, in a respective axis parallel to the optical axis, between a respective corner drive magnet and the substrate.

Clause 25: The camera of any one of Clauses 21-24, wherein the lens group comprises one or more glass lens elements, and wherein the lens group is fixedly coupled with a stationary component of the camera.

Clause 26: The camera of any one of Clauses 21-25, wherein the drive coils comprise: a first drive coil capable of being driven with a first respective drive current; a second drive coil capable of being driven with a second respective drive current; a third drive coil capable of being driven with a third respective drive current; and a fourth drive coil capable of being driven with a fourth respective drive current.

Clause 27: The camera of Clause 26, wherein, when using the one or more VCM actuators to tilt the image sensor, the first respective drive current is different than at least one of: the respective second drive current; the respective third drive current; or the respective fourth drive current.

Clause 28: The camera of any one of Clauses 21-27, wherein the drive coils are oriented such that, when driven with an electric current, the electric current flows along multiple directions orthogonal to the optical axis.

Clause 29: A device, comprising: one or more processors; memory storing program instructions executable by the one or more processors to control operations of a camera; and the camera, comprising: a lens group; an image sensor; one or more voice coil motor (VCM) actuators, comprising: fixed drive magnets, wherein each of the fixed drive magnets has a polarity along a vertical direction parallel to an optical axis of the camera; and drive coils; and a substrate coupled with the image sensor and with the drive coils, wherein each respective drive coil is positioned proximate a respective fixed drive magnet such that, when driven with electric current, one or more of the drive coils are capable of electromagnetically interacting with one or more of the fixed drive magnets to move the image sensor, together with the substrate, relative to the lens group.

Clause 30: The device of Clause 29, wherein the one or more VCM actuators are capable of moving the image sensor in at least one direction parallel to the optical axis.

Clause 31: The device of Clause 29 or Clause 30, wherein the one or more VCM actuators are further capable of tilting the image sensor about multiple axes orthogonal to the optical axis.

Clause 32: The device of any one of Clauses 29-31, wherein the drive coils comprise: a first drive coil positioned proximate a first corner of the substrate; a second drive coil positioned proximate a second corner of the substrate; a third drive coil positioned proximate a third corner of the substrate; and a fourth drive coil positioned proximate a fourth corner of the substrate.

Clause 33: The device of Clause 32, wherein the camera further comprises: a first position sensor encircled by the first drive coil; a second position sensor encircled by the second drive coil; a third position sensor encircled by the third drive coil; and a fourth position sensor encircled by the fourth drive coil.

Clause 34: The device of Clause 32 or Clause 33, wherein the fixed drive magnets comprise: a first fixed drive magnet proximate the first drive coil; a second fixed drive magnet proximate the second drive coil; a third fixed drive magnet proximate the third drive coil; and a fourth fixed drive magnet proximate the fourth drive coil;

Clause 35: The device of Clause 34, wherein the camera further comprises: closed loop passive coils coupled with the substrate, wherein each respective closed loop passive coil of the closed loop passive coils is positioned such that, when the substrate and the respective closed loop passive coil move relative to a respective fixed drive magnet, the respective fixed drive magnet induces a current in the respective closed loop passive coil, and wherein the current produces a magnetic field that opposes the motion of the substrate.

Clause 36: The device of Clause 35: wherein the closed loop passive coils comprise: a first closed loop passive coil, wherein a first axis parallel to the optical axis intersects the first fixed drive magnet, an area within an outer periphery of the first drive coil, and an area within an outer periphery of the first closed loop passive coil; a second closed loop passive coil, wherein a second axis parallel to the optical axis intersects the second fixed drive magnet, an area within an outer periphery of the second drive coil, and an area within an outer periphery of the second closed loop passive coil; a third closed loop passive coil, wherein a third axis parallel to the optical axis intersects the third fixed drive magnet, an area within an outer periphery of the third drive coil, and an area within an outer periphery of the third closed loop passive coil; and a fourth closed loop passive coil, wherein a fourth axis parallel to the optical axis intersects the fourth fixed drive magnet, an area within an outer periphery of the fourth drive coil, and an area within an outer periphery of the fourth closed loop passive coil.

Clause 37: A method, comprising: moving, using one or more voice coil motor (VCM) actuators of a camera, an image sensor of the camera relative to a lens group of the camera, wherein: the image sensor is coupled with a substrate of the camera; the one or more VCM actuators comprise: fixed drive magnets, wherein each of the fixed drive magnets has a polarity along a vertical direction parallel to an optical axis of the camera; and drive coils coupled with the substrate, wherein each respective drive coil is positioned proximate a respective fixed drive magnet such that, when driven with electric current, one or more of the drive coils are capable of electromagnetically interacting with one or more of the fixed drive magnets to move the image sensor; and the moving the image sensor comprises: providing electric current to at least one of the drive coils.

Clause 38: The method of Clause 37, wherein the providing electric current to at least one of the drive coils comprises: providing electric current to multiple ones of the drive coils to move the image sensor, together with the substrate, in at least one direction parallel to the optical axis.

Clause 39: The method of Clause 37 or Clause 38, wherein the providing electric current to at least one of the drive coils comprises: independently driving one or more of the drive coils to tilt the image sensor, together with the substrate, about an axis orthogonal to the optical axis, wherein the one or more VCM actuators are capable of tilting the image sensor about multiple axes orthogonal to the optical axis.

Clause 40: The method of any one of Clauses 37-39, further comprising: determining, based at least in part on output from one or more position sensors, a position of the image sensor, wherein the one or more position sensors comprise a position sensor encircled by a drive coil of the drive coils.

Clause 41: A camera, comprising: a lens group; an image sensor; a moveable carrier coupled with the lens group or the image sensor; one or more voice coil motor (VCM) actuators, comprising: a drive magnet; and a drive coil positioned proximate the drive magnet such that, when driven with electric current, the drive coil is capable of electromagnetically interacting with the drive magnet to move the moveable carrier in at least one direction; and a closed loop passive coil positioned relative to the drive magnet such that, when there is relative motion between the drive magnet and the closed loop passive coil caused by motion of the moveable carrier, the drive magnet induces a current in the closed loop passive coil, wherein the current produces a magnetic field that opposes the motion of the moveable carrier, thereby providing electromagnetic damping.

Clause 42: The camera of Clause 41, wherein a magnitude the electromagnetic damping is proportional to the speed of the motion.

Clause 43: The camera of Clause 41 or Clause 42, further comprising: a shield can that encases at least a portion of the camera; wherein: the lens group is fixedly attached to the shield can such that the shield can abuts a portion of the lens group along an entire outer circumference of the portion; and the image sensor is fixedly coupled with the moveable carrier.

Clause 44: The camera of Clause 43, wherein: the lens group comprises one or more lens elements that define an optical axis; the moveable carrier has an outer periphery, along a plane orthogonal to the optical axis, that is spaced apart, along the plane, from an inner surface of the shield can by a gap distance that is sized based on a predetermined amount of desired air damping provided by resistance from the moveable carrier pushing air during motion.

Clause 45: The camera of Clause 44, wherein the resistance increases as the gap distance decreases.

Clause 46: The camera of any one of Clauses 41-45, wherein the drive magnet has a polarity along a vertical direction parallel to an optical axis of the camera.

Clause 47: The camera of any one of Clauses 41-46, wherein the image sensor, the drive coil, and the closed loop passive coil are fixedly coupled with the moveable carrier.

Clause 48: The camera of any one of Clauses 41-47, wherein: the drive coil is on a first side of the moveable carrier; the closed loop passive coil is on a second side of the moveable carrier; and the first side and the second side face in opposite directions.

Clause 49: A device, comprising: one or more processors; memory storing program instructions executable by the one or more processors to control operations of a camera; and the camera, comprising: a lens group; an image sensor; a moveable carrier coupled with the lens group or the image sensor; one or more voice coil motor (VCM) actuators, comprising: a drive magnet; and a drive coil positioned proximate the drive magnet such that, when driven with electric current, the drive coil is capable of electromagnetically interacting with the drive magnet to move the moveable carrier in at least one direction; and a closed loop passive coil positioned relative to the drive magnet such that, when there is relative motion between the drive magnet and the closed loop passive coil caused by motion of the moveable carrier, the drive magnet induces a current in the closed loop passive coil, wherein the current produces a magnetic field that opposes the motion of the moveable carrier, thereby providing electromagnetic damping.

Clause 50: The device of Clause 49, wherein the drive magnet has a polarity along a vertical direction parallel to an optical axis of the camera.

Clause 51: The device of Clause 49 or Clause 50, wherein: the lens group and the drive magnet are fixedly attached to a stationary component of the camera; and the image sensor, the drive coil, and the closed loop passive coil are fixedly coupled with the moveable carrier.

Clause 52: The device of any one of Clauses 49-51, the one or more VCM actuators comprise: a plurality of fixed drive magnets, including the drive magnet; and a plurality of drive coils, including the drive coil; and each respective drive coil of the plurality of drive coils is positioned proximate a corresponding respective fixed drive magnet of the plurality of fixed drive magnets.

Clause 53: The device of any one of Clauses 49-52, wherein each drive coil of the plurality of drive coils is capable of being independently driven.

Clause 54: The device of any one of Clauses 49-53, wherein the one or more VCM actuators are capable of tilting the image sensor about multiple axes orthogonal to an optical axis of the camera.

Clause 55: The device of any one of Clauses 49-54, wherein the one or more VCM actuators are capable of moving the image sensor in at least one direction parallel to an optical axis of the camera.

Clause 56: The device of any one of Clauses 49-55, wherein: the plurality of fixed drive magnets are corner drive magnets, wherein each corner drive magnet is positioned proximate a respective corner of the camera; and the plurality of drive coils are corner drive coils, wherein each drive coil is positioned proximate a respective corner of the camera.

Clause 57: The device of any one of Clauses 49-56, wherein: the camera comprises a plurality of closed loop passive coils, including the closed loop passive coil; and each respective closed loop passive coil of the plurality of closed loop passive coils is a corner closed loop passive coil that is positioned proximate a respective corner of the camera.

Clause 58: A system, comprising: an image sensor; a moveable carrier coupled with the image sensor; a drive coil, of a voice coil motor (VCM) actuator of a camera, coupled with the moveable carrier, wherein the drive coil is positioned such that, when the moveable carrier is mounted in the camera and when driven with an electric current, the drive coil is capable of electromagnetically interacting with a drive magnet of the VCM actuator to move the moveable carrier; and a closed loop passive coil coupled with the moveable carrier, wherein the closed loop passive coil is positioned such that, when the moveable carrier is mounted in the camera and when the closed loop passive coil moves relative to the drive magnet, the drive magnet induces a current in the closed loop passive coil, wherein the current produces a magnetic field that opposes the motion of the moveable carrier.

Clause 59: The system of Clause 58, wherein: the drive coil is on a first side of the moveable carrier; the closed loop passive coil is on a second side of the moveable carrier; and the first side and the second side face in opposite directions.

Clause 60: The system of Clause 58 or Clause 59, further comprising: a flexure that suspends the moveable carrier and that allows motion of the moveable carrier enabled by the VCM actuator, wherein the flexure comprises: an inner frame coupled with the movable carrier; an outer frame coupled with one or more stationary components of the camera; and one or more flexure arms that extend from the inner frame to the outer frame.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
a lens group;
an image sensor;
one or more voice coil motor (VCM) actuators, comprising:
fixed drive magnets; and
drive coils; and
a substrate coupled with the image sensor and with the drive coils, wherein each respective drive coil is positioned proximate a respective fixed drive magnet such that, when driven with electric current, one or more of the drive coils are capable of electromagnetically interacting with one or more of the fixed drive magnets to tilt the image sensor relative to the lens group, and wherein the one or more VCM actuators are capable of tilting the image sensor about multiple axes orthogonal to an optical axis of the camera.

2. The camera of claim 1, wherein each of the fixed drive magnets has a respective polarity along a vertical direction parallel to the optical axis.

3. The camera of claim 1, wherein the drive coils comprise:
a first drive coil capable of being driven with a first respective drive current;
a second drive coil capable of being driven with a second respective drive current;
a third drive coil capable of being driven with a third respective drive current; and
a fourth drive coil capable of being driven with a fourth respective drive current.

4. The camera of claim 3, wherein, when using the one or more VCM actuators to tilt the image sensor, the first respective drive current is different than at least one of:
the respective second drive current;
the respective third drive current; or
the respective fourth drive current.

5. The camera of claim 1, wherein:
the fixed drive magnets are corner drive magnets, wherein each corner drive magnet is positioned proximate a respective corner of the camera;
the drive coils are corner drive coils, wherein each corner drive coil is positioned proximate a respective corner of the camera; and
each respective corner drive coil is positioned, in a respective axis parallel to the optical axis, between a respective corner drive magnet and the substrate.

6. The camera of claim 1, wherein the lens group comprises one or more glass lens elements; and the lens group is fixedly coupled with a stationary component of the camera.

7. The camera of claim 6, wherein the stationary component is a shield can of the camera.

8. The camera of claim 1, wherein, when driven with electric current, the drive coils are further capable of electromagnetically interacting with the fixed drive magnets to move the image sensor in at least one direction parallel to the optical axis.

9. A device, comprising:
one or more processors;
memory storing program instructions executable by the one or more processors to control operations of a camera; and
the camera, comprising:
a lens group;
an image sensor;
one or more voice coil motor (VCM) actuators, comprising:
fixed drive magnets; and
drive coils; and
a substrate coupled with the image sensor and with the drive coils, wherein each respective drive coil is positioned proximate a respective fixed drive magnet such that, when driven with electric current, one or more of the drive coils are capable of electromagnetically interacting with one or more of the fixed drive magnets to tilt the image sensor relative to the lens group, and wherein the one or more VCM actuators are capable of tilting the image sensor about multiple axes orthogonal to an optical axis of the camera.

10. The device of claim 9, wherein each of the fixed drive magnets has a respective polarity along a vertical direction parallel to the optical axis.

11. The device of claim 9, wherein each of the drive coils is capable of being independently driven.

12. The device of 9, wherein the drive coils are oriented such that, when driven with an electric current, the electric current flows along multiple directions orthogonal to the optical axis.

13. The device of claim 9, wherein the camera further comprises:
position sensors, wherein each respective position sensor is encircled by a respective drive coil.

14. The device of claim 9, wherein, when driven with electric current, the drive coils are further capable of electromagnetically interacting with the fixed drive magnets to move the image sensor in at least one direction parallel to the optical axis.

15. The device of claim 9, wherein the camera further comprises:
a closed loop passive coil coupled with the substrate and positioned relative to a fixed drive magnet of the fixed drive magnets such that, when there is relative motion between fixed drive magnet and the closed loop passive coil caused by motion of the substrate, the fixed drive magnet induces a current in the closed loop passive coil, wherein the current produces a magnetic field that opposes the motion of the substrate, thereby providing electromagnetic damping.

16. The device of claim 9, wherein the camera further comprises:
an encasing that provides a sealed environment for an interior portion of the camera, wherein the sealed environment protects the interior portion from particle ingression, and wherein the encasing comprises:
a shield can; and
a sealed interface between the lens group and the shield can, wherein the lens group is fixedly attached to the shield can.

17. A system, comprising:
an image sensor;
a substrate coupled with the image sensor; and
drive coils, of one or more voice coil motor (VCM) actuators of a camera, coupled with the substrate, wherein each respective drive coil is positioned proximate a respective fixed drive magnet of the one or more VCM actuators such that, when driven with electric current, one or more of the drive coils are capable of electromagnetically interacting with one or more of the fixed drive magnets to tilt the image sensor, and wherein the one or more VCM actuators are capable of tilting the image sensor about multiple axes orthogonal to an optical axis of the camera.

18. The system of claim 17, wherein, when driven with electric current, the drive coils are further capable of electromagnetically interacting with the fixed drive magnets to move the image sensor in at least one direction parallel to the optical axis.

19. The system of claim 17, further comprising:
a closed loop passive coil coupled with the substrate and positioned relative to a fixed drive magnet of the fixed drive magnets such that, when there is relative motion between fixed drive magnet and the closed loop passive coil caused by motion of the substrate, the fixed drive magnet induces a current in the closed loop passive coil, wherein the current produces a magnetic field that opposes the motion of the substrate, thereby providing electromagnetic damping.

20. The system of claim 17, further comprising:
a flexure that suspends the substrate and that allows motion of the substrate enabled by the one or more VCM actuators, wherein the flexure comprises:
an inner frame coupled with the substrate;
an outer frame coupled with one or more stationary components of the camera; and
one or more flexure arms that extend from the inner frame to the outer frame.
